(19) United States
(12) Patent Application Publication
(10) Pub. No.: US 2026/0011162 A1
(43) Pub. Date: Jan. 8, 2026

(54) OBJECT DETECTION DEVICE AND OBJECT DETECTION METHOD

(71) Applicant: NEC Corporation, Tokyo (JP)

(72) Inventor: Seiya SHIBATA, Tokyo (JP)

(73) Assignee: NEC Corporation, Tokyo (JP)

(21) Appl. No.: 19/237,284

(22) Filed: Jun. 13, 2025

(30) Foreign Application Priority Data
Jul. 2, 2024 (JP) 2024-106736

(51) Int. Cl. G06V 20/70; G06T 7/73; G06V 10/26; G06V 10/764

(52) U.S. Cl. CPC G06V 20/70; G06T 7/73; G06V 10/26; G06V 10/764; G06T 2207/20081

(57) ABSTRACT

A first detection unit that identifies a label of an object reflected in an input frame and a location of a bounding box of the object, and predicts an area of the bounding box in a frame input later than the frame based on history of the location of the bounding box of the same object. A second detection unit that identifies the label of the reflected object and the location of the bounding box of the object, in the predicted area of the bounding box in the frame input later. The first detection unit and the second detection unit share a hardware resource. The arbitration unit controls turning on and off of a start prohibition flag which is to prohibit start of a processing of the first detection unit.

### INCORPORATION BY REFERENCE

This application is based upon and claims the benefit of priority from Japanese patent application No. 2024-106736, filed on Jul. 2, 2024, the disclosure of which is incorporated herein in its entirety by reference.

### Technical Field

The present disclosure relates to an object detection device, an object detection method, and an object detection program.

### BACKGROUND ART

### Background Technology

PTL 1 describes a monitoring device including camera control means having at least two control modes depending on moving speed of an object.

### CITATION LIST

### Patent Literature

PTL 1: Japanese Patent Application Laid-Open No. 2019-68184

### SUMMARY

“Detecting an object” means identifying a label of the object reflected in a frame input from a camera and a location of a bounding box of the object. The label is a label indicating type of the object reflected in the frame. For example, when the objects to be detected are a passenger car and a person, the label “car” or “person” is identified as the label of an object.

As an object detection device that detects objects from frames continuously input from a camera, the inventor considered following object detection device. FIG. 8 is a block diagram showing the object detection device considered by the inventor. The object detection device 100 includes a first detection unit 111, a second detection unit 112, and a pre-processing unit 121.

The first detection unit 111 can detect objects from frames with high accuracy, however the detection takes time.

The second detection unit 112 can detect objects in a short time, although the detection accuracy is low.

Even though the detection takes time in the first detection unit 111, it is assumed that the desired throughput (F [fps]) can be achieved. In other words, it is assumed that the first detection unit 111 and the second detection unit 112 can process one frame each during 1/F second. Furthermore, [fps] is an abbreviation for “frames per second”. In this case, one period is 1/F second.

The first detection unit 111 and the second detection unit 112 are realized by a processor that cannot be interrupted in processing. Examples of processors that cannot be interrupted in processing include a GPU (Graphics Processing Unit) and an AI (Artificial Intelligence) chip. The following description uses the case where the first detection unit 111 and the second detection unit 112 are realized by a GPU 110 as an example.

The pre-processing unit 121 is realized by a CPU (Central Processing Unit) 120, which is provided separately from the GPU 110.

Pre-processing is required for the detection. Examples of the pre-processing include image resizing, color conversion (e.g., RGB to GBR), and data type conversion (e.g., int to float). The pre-processing of the detection of the second detection unit 112 is equivalent to the detection of the second detection unit 112 in terms of delay. Therefore, it is assumed that the pre-processing of the detection of the second detection unit 112 is included in the processing of the second detection unit 112 and performed by the GPU 110.

The pre-processing of the detection of the first detection unit 111 has a low priority in terms of delay. Therefore, it is assumed that the pre-processing of the detection of the first detection unit 111 is performed by CPU 120 (the pre-processing unit 121).

When the first detection unit 111 identifies a label of an object in an frame and a location of a bounding box by detection, the first detection unit 111 predicts an area of the bounding box several frames ahead, for example, based on the history of the location of the bounding box, and outputs the predicted area of the bounding box the second detection unit 112. The second detection unit 112 identifies the label of the reflected object and the location of the bounding box of the object, in the predicted area of the bounding box.

The second detection unit 112 performs detection in the area of the bounding box predicted by the first detection unit 111, allowing both low latency and object detection accuracy with respect to object detection.

FIG. 9 is an ideal timing chart for the object detection device shown in FIG. 8. The numbers shown in FIG. 9 represent frame numbers. DL seconds is the time from when a frame is input to the GPU 110 until the second detection unit 112 starts processing the frame. DH seconds is the time for the pre-processing unit 121 to perform the pre-process of the detection by the first detection unit 111. The value of DH can vary. The processing time for the processing performed by the second detection unit 112 within one period is assumed to be constant at PL seconds. Similarly, the processing time for the processing performed by the first detection unit 111 within one period is assumed to be constant at PH seconds. The values of PL and PH are constants that can be obtained by approximately accurate estimation.

In the example shown in FIG. 9, the first detection unit 111 predicts the area of the bounding box one frame ahead and communicates the area to the second detection unit 112. The second detection unit 112 detects the object in the predicted area.

In the ideal timing chart shown in FIG. 9, the object detection result is obtained by the second detection unit 112 after (DL+PL) seconds after the frame input.

FIG. 10 is a timing chart showing an example of a case in which pre-processing by the pre-processing unit 121 takes time. Since the pre-processing time is variable, there are cases in which pre-processing takes time.

As shown in FIG. 10, it is assumed that in the second period, the pre-processing takes time and the pre-processing time is DH′ seconds. Then, the end timing of the processing of the first detection unit 111, which started in the second period, is delayed. Here, the processing of the second detection unit 112 cannot interrupt, so in the third period, the processing of the second detection unit 112 starts at the end of the processing of the first detection unit 111. As a result, in the third period, the object detection result is obtained (α+PL) seconds after the frame input.

It is preferable that the time from the frame input to the end of processing by the second detection unit 112 is (DL+PL) seconds, as illustrated in FIG. 9.

Therefore, the purpose of present disclosure is to provide an object detection device, an object detection method, and an object detection program that can avoid delay of the end timing of the processing of the second detection unit.

An object detection device according to the present disclosure is an object detection device to which frames are input consecutively, comprising: a first detection unit that identifies a label of an object reflected in an input frame and a location of a bounding box of the object, and predicts an area of the bounding box in a frame input later than the frame based on history of the location of the bounding box of the same object; and a second detection unit that identifies the label of the reflected object and the location of the bounding box of the object, in the predicted area of the bounding box in the frame input later; wherein the first detection unit and the second detection unit share a hardware resource, wherein the object detection device comprises: an arbitration unit that, when frame input period is denoted as 1/F second, processing time of the first detection unit corresponding to one period is denoted as PH seconds, and processing time of the second detection unit corresponding to one period is denoted as PL seconds, controls turning on and off of a start prohibition flag which is to prohibit start of a processing of the first detection unit, based on 1/F, PH and PL, and wherein the first detection unit starts the processing when the start prohibition flag is off.

An object detection method according to the present disclosure is an object detection method applied to an object detection device to which frames are input consecutively, wherein a first detection unit of the object detection device identifies a label of an object reflected in an input frame and a location of a bounding box of the object, and predicts an area of the bounding box in a frame input later than the frame based on history of the location of the bounding box of the same object; a second detection unit of the object detection device identifies the label of the reflected object and the location of the bounding box of the object, in the predicted area of the bounding box in the frame input later; an arbitration unit of the object detection device, when frame input period is denoted as 1/F second, processing time of the first detection unit corresponding to one period is denoted as PH seconds, and processing time of the second detection unit corresponding to one period is denoted as PL seconds, controls turning on and off of a start prohibition flag which is to prohibit start of a processing of the first detection unit, based on 1/F, PH and PL; and the first detection unit starts the processing when the start prohibition flag is off.

A non-transitory computer-readable recording medium according to the present disclosure is a non-transitory computer-readable recording medium in which an object detection program is recorded, wherein the object detection program is to be installed in a computer to which frames are input consecutively, and the object detection program causes the computer to execute: a first detection process of identifying a label of an object reflected in an input frame and a location of a bounding box of the object, and predicting an area of the bounding box in a frame input later than the frame based on history of the location of the bounding box of the same object; a second detection process of identifying the label of the reflected object and the location of the bounding box of the object, in the predicted area of the bounding box in the frame input later; and an arbitration process of, when frame input period is denoted as 1/F second, processing time of the first detection process corresponding to one period is denoted as PH seconds, and processing time of the second detection process corresponding to one period is denoted as PL seconds, controlling turning on and off of a start prohibition flag which is to prohibit start of the first detection process, based on 1/F, PH and PL, wherein the object detection program causes the computer to start the first detection process when the start prohibition flag is off.

### BRIEF DESCRIPTION OF THE DRAWINGS

FIG. 1 It depicts a block diagram showing an example configuration of an object detection device of the present disclosure.

FIG. 2 It depicts a schematic diagram showing an example of history information.

FIG. 3 It depicts a timing chart showing an example of operation of the object detection device of the present disclosure.

FIG. 4 It depicts a timing chart for a case where the arbitration unit 6 turns off start prohibition flag immediately after the start of the processing time of the second detection unit 3.

FIG. 5 It depicts an example of a timing chart when processing for multiple frames is combined into one process and then divided into the first half and the second half of the process.

FIG. 6 It depicts a schematic block diagram showing an example configuration of a computer related to the object detection device of the present disclosure.

FIG. 7 It depicts a block diagram showing an overview of the object detection device of the present disclosure.

FIG. 8 It depicts a block diagram showing an object detection device considered by the inventor.

FIG. 9 It depicts an ideal timing chart for the object detection device shown in FIG. 8.

FIG. 10 It depicts a timing chart showing an example of a case in which pre-processing by the pre-processing unit 121 takes time.

### EXAMPLE EMBODIMENT

The following is a description of the example embodiments of the present disclosure with reference to the drawings.

As mentioned above, “detecting an object” means identifying a label of the object reflected in a frame input from a camera and a location of a bounding box of the object.

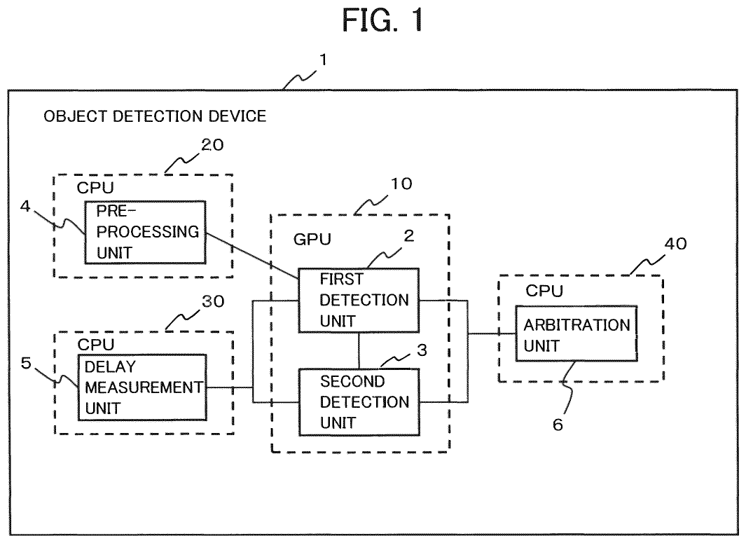

FIG. 1 is a block diagram showing an example configuration of an object detection device of the present disclosure. The object detection device 1 includes a first detection unit 2, a second detection unit 3, a pre-processing unit 4, a delay measurement unit 5, and an arbitration unit 6.

The first detection unit 2 and the second detection unit 3 are realized by a processor that cannot be interrupted in processing. Examples of processors that cannot be interrupted in processing include a GPU and an AI chip. The following description uses the case where the first detection unit 2 and the second detection unit 3 are realized by a GPU 10. The first detection unit 2 and the second detection unit 3 share a hardware resource, the GPU 10.

The first detection unit 2 can detect objects from frames with high accuracy, however the detection takes time.

The second detection unit 3 can detect objects in a short time, although the detection accuracy is low.

Even though the detection takes time in the first detection unit 2, it is assumed that the desired throughput (F [fps]) can be achieved. In other words, it is assumed that the first detection unit 2 and the second detection unit 3 can process one frame each during 1/F second.

The pre-processing unit 4 is realized by a CPU 20.

The delay measurement unit 5 is realized by a CPU 30.

The arbitration unit 6 is realized by a CPU 40.

The pre-processing unit 4, the delay measurement unit 5, and the arbitration unit 6 may be realized by a same CPU.

The GPU 10 is continuously input with frames generated by camera shooting. Sequential frame numbers are defined for frames that are input consecutively. Each frame is assumed to be input to the GPU10 at a fixed frame rate. This frame rate is denoted as F[fps].

The first detection unit 2, for example, maintains a model generated in advance by machine learning such as deep learning. The first detection unit 2 identifies a label of an object reflected in a frame and a location of a bounding box of the object by applying the entire single input frame to the model. The number of objects detected from a single frame is not limited to one, but may be multiple. In that case, for each object, the first detection unit 2 identifies the label of the object and the location of the bounding box of the object.

When the first detection unit 2 detects an object from a frame, the first detection unit 2 assigns an ID to the identified bounding box. When multiple bounding box locations are obtained, the first detection unit 2 assigns an ID to each bounding box. In this case, the first detection unit 2 assigns the same ID to the bounding boxes with which the object is common (in other words, the bounding boxes with which the object is presumed to be common).

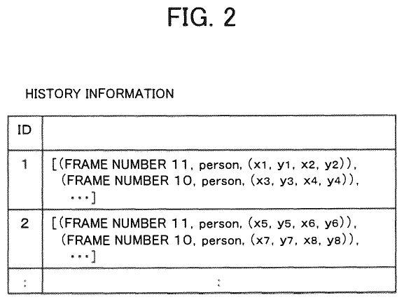

The first detection unit 2 then generates history information. The history information is information that indicates the history of combination of the frame number and the location of the bounding box for each ID. FIG. 2 is a schematic diagram showing an example of the history information. The example shown in FIG. 2 shows the history of the combination of the frame number, the label, and the location of the bounding box for each ID of the bounding box. In this example, the location of the bounding box is identified by the coordinates of the upper left vertex and the coordinates of the lower right vertex of the bounding box. For example, (x₁, y₁) shown in FIG. 2 are the coordinates of the upper left vertex of the bounding box and (x₂, y₂) are the coordinates of the lower right vertex of the bounding box.

Based on the history information, the first detection unit 2 predicts the area of the bounding box in a frame input later than the frame in which the object was detected. How much later the area of the bounding box in the input frame is predicted is determined by the delay measurement unit 5.

The delay measurement unit 5 monitors the frame number of the frame being processed by the first detection unit 2 and the frame number of the next frame to be input to the second detection unit 3, and subtracts the former from the latter. The first detection unit 2 predicts the area of the bounding box in the later frame by the amount of the subtraction result. For example, it is assumed that the frame number of the frame being processed by the first detection unit 2 is 11 and the next frame number to be input to the second detection unit 3 is 13. In this case, the first detection unit 2 predicts the area of the bounding box in the frame 2 (=13-11) frames later than the frame currently being processed.

Based on the history information, the first detection unit 2 may predict the area of the bounding box in the frame input after the frame in which the object was detected by linear prediction.

Alternatively, the first detection unit 2 may predict the area of the bounding box in the frame input after the frame in which the object was detected, by the Kalman filter based on the history information. Based on the history information, the first detection unit 2 may predict the area of the bounding box in the frame input after the frame in which the object was detected, by a movement prediction model generated by machine learning, such as deep learning.

The first detection unit 2 outputs the predicted area of the bounding box in the later input frame to the second detection unit 3.

The second detection unit 3 identifies the label of the reflected object and the location of the bounding box of the object, in the area of the bounding box predicted by the first detection unit 2 in the latest input frame. When there are multiple areas of the bounding boxes predicted by the first detection unit 2, the second detection unit 3 identifies the label of the reflected object and the location of the bounding box of the object for each predicted area of the bounding box.

The second detection unit 3, for example, maintains a model generated in advance by machine learning such as deep learning. Then, by applying the predicted area of the bounding box in the latest frame to the model, the second detection unit 3 identifies the label of the reflected object and the location of the bounding box of the object. The size of the model maintained by the second detection unit 3 may be smaller than the size of the model maintained by the first detection unit 2.

At the end of the processing, the second detection unit 3 sends a notification to the arbitration unit 6 that the processing has been completed. The arbitration unit 6 recognizes that the processing of the second detection unit 3 has been completed by this notification.

The pre-processing unit 4 performs the pre-processing of the detection performed by the first detection unit 2. As mentioned above, examples of the pre-processing include image resizing, color conversion, and data type conversion. The time for this pre-processing can vary.

Since the processing volume of the pre-processing of the detection in the second detection unit 3 is small, the pre-processing of the detection in the second detection unit 3 is included in the processing of the second detection unit 3 and is performed by the GPU 10.

When frames are input at the frame rate of F [fps], the frame input period is 1/F second.

The processing time for the processing performed by the first detection unit 2 within one period is assumed to be constant at PH seconds. Similarly, the processing time for the processing performed by the second detection unit 3 within one period is assumed to be constant at PL seconds. The values of PH and PL are constants that can be obtained by approximately accurate estimation. It is also assumed that PH+PL<1/F.

Based on 1/F, PH, and PL, the arbitration unit 6 controls the turning on and off of a start prohibition flag which is to prohibit the start of the processing of the first detection unit 2. Specifically, the arbitration unit 6 turns on the start prohibition flag (1/F-PL-PH) seconds after the end of the processing time of the second detection unit 3 corresponding to one period, and turns off the start prohibition flag at any time from immediately after the start of the processing time of the second detection unit 3 corresponding to the next period to the end of the processing time.

The first detection unit 2 does not start processing when the start prohibition flag is on, but starts processing when the start prohibition flag is off. Once the first detection unit 2 starts processing, the first detection unit 2 may continue the processing even if the start prohibition flag is turned on during the processing.

When the processing of the first detection unit 2 is started more than (1/F-PL-PH) seconds after the end of the processing of the second detection unit 3, the processing of the first detection unit 2 will always overlap with the ideal processing timing of the second detection unit 3 in the next period, and the start of the processing of the second detection unit 3 in the next period will be delayed. Therefore, the arbitration unit 6 turns on the start prohibition flag (1/F-PL-PH) seconds after the end of the processing time of the second detection unit 3 corresponding to one period, so that the first detection unit 2 cannot start processing until the start prohibition flag is turned off.

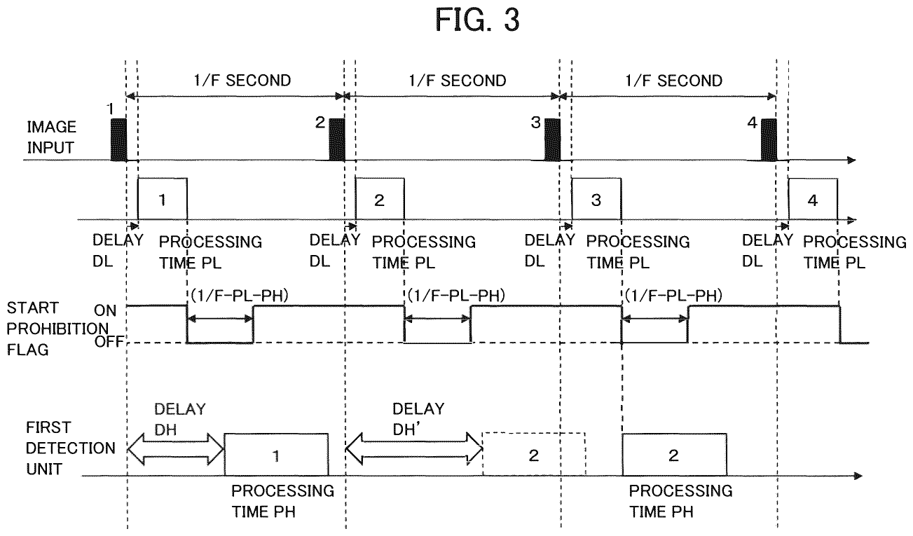

FIG. 3 is a timing chart showing an example of the operation of the object detection device of the present disclosure. The numbers shown in FIG. 3 represent frame numbers.

In FIG. 3, DL seconds is the time from when a frame is input to the GPU 10 until the second detection unit 3 starts processing the frame. DH seconds and DH′ seconds shown in FIG. 3 are the time for the pre-processing unit 4 to perform the pre-process of the detection by the first detection unit 2. DL seconds is shorter than the time for the pre-processing unit 4 to perform the pre-processing.

In FIG. 3, the case in which the arbitration unit 6 turns off the start prohibition flag at the end of the processing time of the second detection unit 3 is used as an example.

It is assumed that a period starts when a frame is input. In the first period, when DL seconds have elapsed since the start of the period, the second detection unit 3 starts processing. When this processing is completed, the second detection unit 3 sends the notification to the arbitration unit 6 that the processing has been completed. Upon receipt of this notification, the arbitration unit 6 turns off the start prohibition flag, and then turns on the start prohibition flag (1/F-PL-PH) seconds after this point.

In the first period, the pre-processing by the pre-processing unit 4 is completed during the duration when the start prohibition flag is off (see FIG. 3), so at the end of the pre-processing, the first detection unit 2 starts the processing for frame 1. Even if the start prohibition flag is turned on after the start of this processing, the first detection unit 2 may continue the processing. Here, since the frame number of the next frame to be input to the second detection unit 3 is 2, the first detection unit 2 detects the object and then predicts the area of the bounding box in the frame one frame after frame 1 (i.e., frame 2). The first detection unit 2 outputs the predicted area of the bounding box to the second detection unit 3.

In the second period, at DL seconds after the start of the period, the second detection unit 3 starts the processing. At this time, the second detection unit 3 performs detection on the area of the bounding box predicted by the first detection unit 2 in frame 2, and outputs the detection results (the label of the object and the location of the bounding box of the object).

The arbitration unit 6 turns off the start prohibition flag at the end of the processing by the second detection unit 3 and turns on the start prohibition flag (1/F-PL-PH) seconds after this point.

In the second period, the pre-processing by the pre-processing unit 4 is completed during the duration when the start prohibition flag is on (see FIG. 3). Therefore, the first detection unit 2 cannot start the processing on frame 2 at the end of the pre-processing.

In the third period, at the elapse of DL seconds after the start of the period, the second detection unit 3 starts the processing. Then, at the elapse of PL seconds after the start of the processing (i.e., (DL+PL) seconds after the start of the period), the arbitration unit 6 turns off the start prohibition flag. At this point, the first detection unit 2 starts the processing for frame 2 (see FIG. 3). Even if the start prohibition flag is turned on after the start of this processing, the first detection unit 2 may continue the processing.

Here, since the frame number of the next frame to be input to the second detection unit 3 is 4, the first detection unit 2 detects the object and then predicts the area of the bounding box in the frame two frames after frame 2 (i.e., frame 4). The first detection unit 2 outputs the predicted area of the bounding box to the second detection unit 3.

In the fourth period, at DL seconds after the start of the period, the second detection unit 3 starts the processing. In frame 4, the second detection unit 3 performs detection on the area of the bounding box predicted by the first detection unit 2, and outputs the detection results (the label of the object and the location of the bounding box of the object).

The arbitration unit 6 turns off the start prohibition flag at the end of the processing by the second detection unit 3 and turns on the start prohibition flag (1/F-PL-PH) seconds after this point.

In this way, the object detection device 1 proceeds with the process.

According to the present disclosure, in each period, the second detection unit 3 can finish the processing (DL+PL) seconds after the start of the period, avoiding a delay in the end timing of the second detection unit 3 processing.

In FIG. 3, the case in which the arbitration unit 6 turns off the start prohibition flag at the end of the processing time of the second detection unit 3 is illustrated as an example. Here, during the processing of the second detection unit 3, the first detection unit 2 cannot start the processing even if the start prohibition flag is off, because the GPU 10 cannot interrupt the processing.

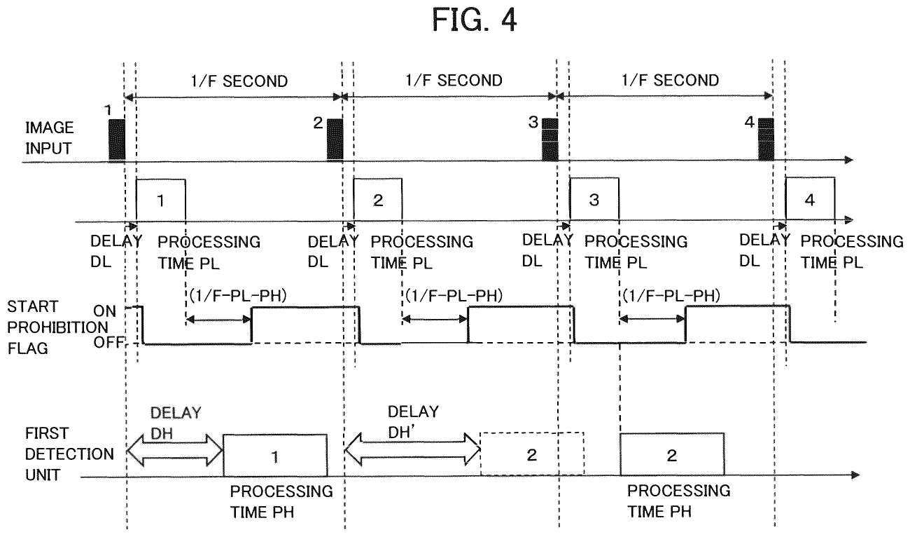

Therefore, the timing at which the arbitration unit 6 turns off the start prohibition flag from on to off may be any time from immediately after the start of the processing time of the second detection unit 3 to the end of the processing time. FIG. 4 is a timing chart for a case where the arbitration unit 6 turns off the start prohibition flag immediately after the start of the processing time of the second detection unit 3. In the example shown in FIG. 4, the timing is the same as in the example shown in FIG. 3, except for the timing at which the arbitration unit 6 turns off the start prohibition flag from on. Therefore, in the example shown in FIG. 4, in each period, the second detection unit 3 can finish the processing (DL+PL) seconds after the start of the period, avoiding a delay in the end timing of the second detection unit 3 processing.

The above example embodiment shows a case in which the first detection unit 2 and the second detection unit 3 share the GPU 10 as a hardware resource. The first detection unit 2 and the second detection unit 3 may be realized by different processors, and the two processors may share a memory and communication paths as hardware resources. In this case, the same operation as in the above example embodiment can be used to avoid delays in the end timing of the processing of the second detection unit 3.

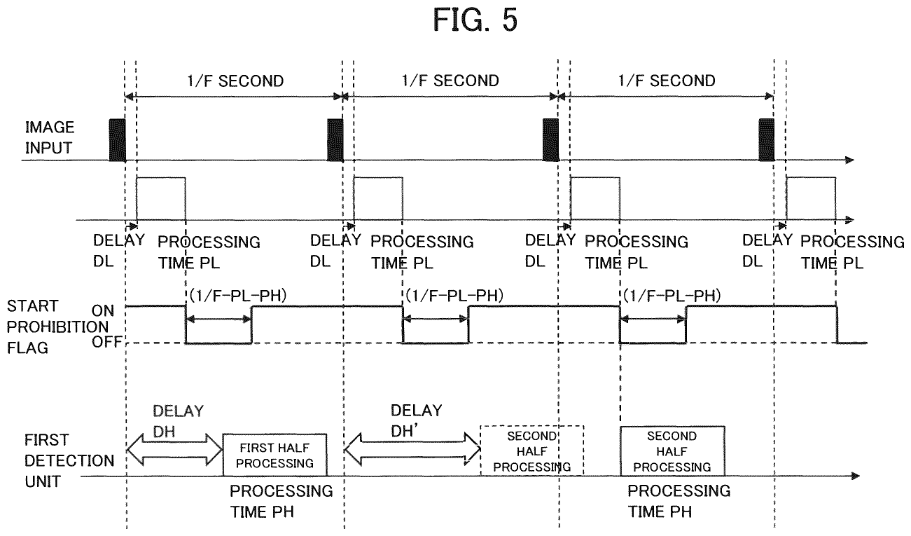

In the above example embodiment, PH+PL was described as PH+PL<1/F. The processing time PH of the first detection unit 2 for one frame may be too long and (PL+PH) may become larger than 1/F second. In such a case, even if the first detection unit 2 processes multiple frames (e.g., three frames) together by parallel processing, etc., the processing time is only slightly longer than the processing time for one frame. When the processing time for these multiple frames (e.g., 3 frames) is divided into the first half processing and the second half processing, and the time for the first half processing and the second half processing are each PH, then PH+PL<1/F can be set. Moreover in this case, the above example embodiment can also be applied. FIG. 5 is an example of a timing chart when processing for multiple frames is combined into one process and then divided into the first half and the second half of the process.

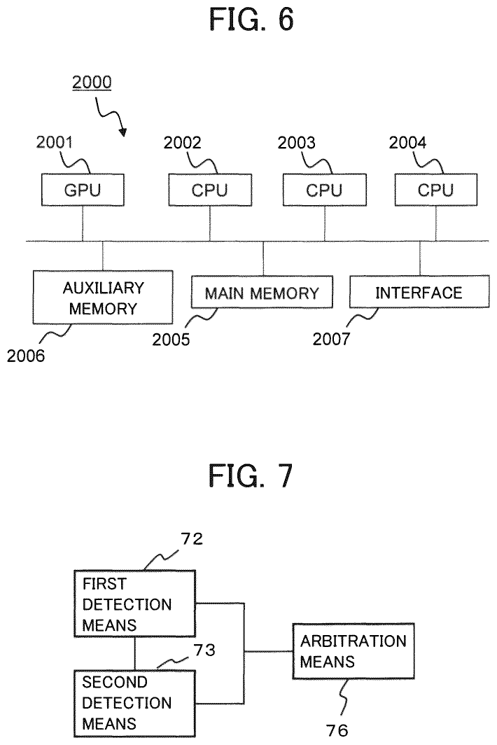

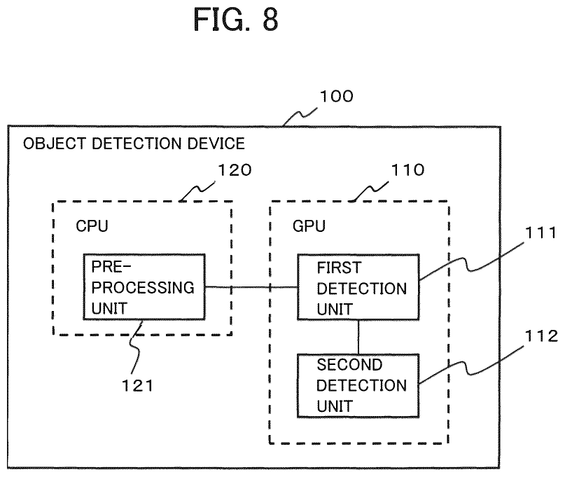

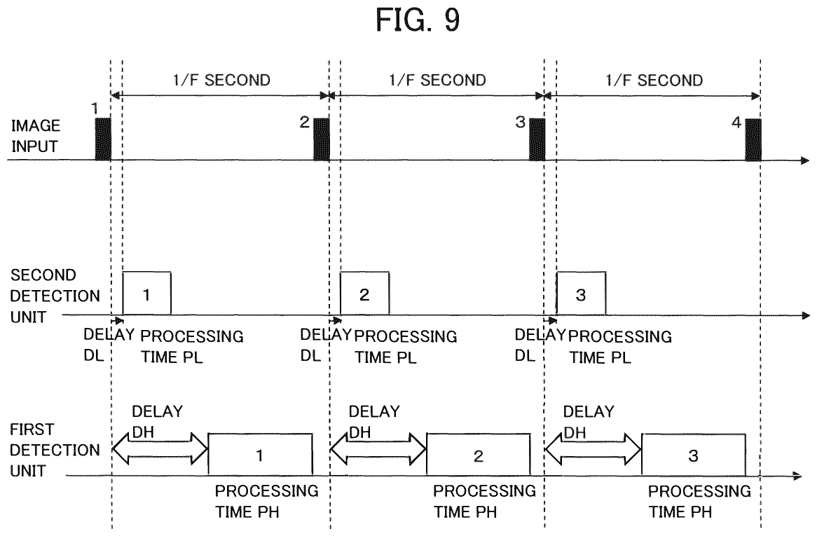

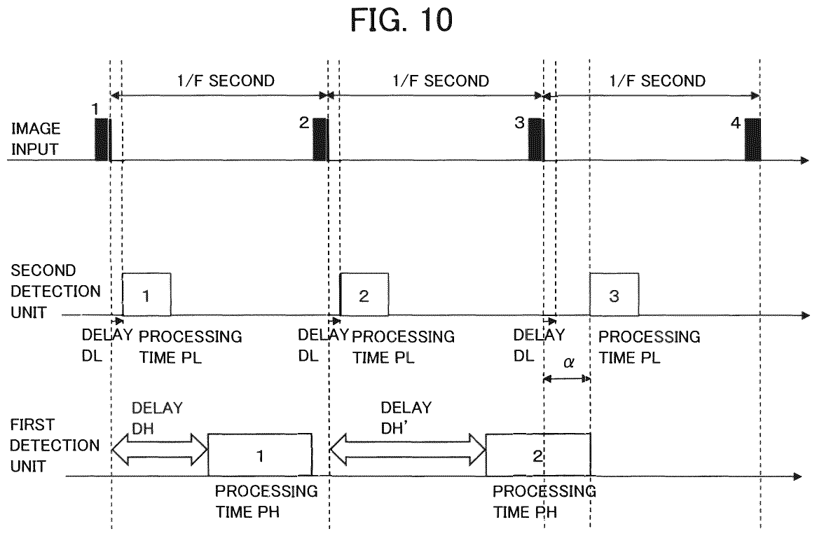

FIG. 6 is a schematic block diagram showing an example configuration of a computer related to the object detection device. The computer 2000, for example, includes a GPU 2001, CPUs 2002-2004, a main memory 2005, an auxiliary memory 2006, and an interface 2007.

The object detection device of the present disclosure is realized, for example, by a computer 2000. The operation of the object detection device is stored in the auxiliary memory 2006 in the form of a program (object detection program). The GPU 2001 and the CPUs 2002-2004 expand the program in the main memory 2005 and execute the processes described in the above example embodiment according to the program. The GPU 2001 operates as the first detection unit 2 and the second detection unit 3. The CPU 2002 operates as the pre-processing unit 4. The CPU 2003 operates as the delay measurement unit 5. The CPU 2004 operates as the arbitration unit 6.

The auxiliary memory 2006 is an example of a non-transitory tangible medium. Other examples of non-transitory tangible media include magnetic disks, magneto-optical disks, CD-ROM (Compact Disk Read Only Memory), DVD-ROM (Digital Versatile Disk Read Only Memory), semiconductor memory, etc., connected via interface 2007.

Next, an overview of the object detection device of the present disclosure is described. FIG. 7 is a block diagram showing an overview of the object detection device of the present disclosure. Frames are consecutively, input to the object detection device of the present disclosure. The object detection device of the disclosure includes first detection means 72, second detection means 73, and arbitration means 76.

The first detection means 72 (e.g., the first detection unit 2) identifies a label of an object reflected in an input frame and a location of a bounding box of the object, and predicts an area of the bounding box in a frame input later than the frame based on history of the location of the bounding box of the same object.

The second detection means 73 (e.g., the second detection unit 3) identifies the label of the reflected object and the location of the bounding box of the object, in the predicted area of the bounding box in the frame input later.

The first detection means 72 and the second detection means 73 share a hardware resource.

The arbitration means 76 (e.g., the arbitration unit 6), when frame input period is denoted as 1/F second, processing time of the first detection means 72 corresponding to one period is denoted as PH seconds, and processing time of the second detection means 73 corresponding to one period is denoted as PL seconds, controls turning on and off of a start prohibition flag which is to prohibit start of a processing of the first detection means 72, based on 1/F, PH and PL.

The first detection means 72 starts the processing when the start prohibition flag is off.

Such a configuration can avoid delay of the end timing of the processing of the second detection means 73.

According to the present disclosure, delay of the end timing of the processing of the second detection unit can be avoided.

The above example embodiment may also be described as, but is not limited to, the following supplementary notes.

### (Supplementary Note 1)

An object detection device to which frames are input consecutively, comprising:
a first detection unit that identifies a label of an object reflected in an input frame and a location of a bounding box of the object, and predicts an area of the bounding box in a frame input later than the frame based on history of the location of the bounding box of the same object; and
a second detection unit that identifies the label of the reflected object and the location of the bounding box of the object, in the predicted area of the bounding box in the frame input later;
wherein the first detection unit and the second detection unit share a hardware resource,
wherein the object detection device comprises:
an arbitration unit that, when frame input period is denoted as 1/F second, processing time of the first detection unit corresponding to one period is denoted as PH seconds, and processing time of the second detection unit corresponding to one period is denoted as PL seconds, controls turning on and off of a start prohibition flag which is to prohibit start of a processing of the first detection unit, based on 1/F, PH and PL, and
wherein the first detection unit starts the processing when the start prohibition flag is off.

### (Supplementary Note 2)

The object detection device according to supplementary note 1,
wherein the arbitration unit turns on the start prohibition flag (1/F-PL-PH) seconds after end of the processing time of the second detection unit corresponding to one period, and turns off the start prohibition flag at any time from immediately after start of the processing time of the second detection unit corresponding to next period to the end the processing time.

### (Supplementary Note 3)

An object detection method applied to an object detection device to which frames are input consecutively,
wherein a first detection unit of the object detection device identifies a label of an object reflected in an input frame and a location of a bounding box of the object, and predicts an area of the bounding box in a frame input later than the frame based on history of the location of the bounding box of the same object;
a second detection unit of the object detection device identifies the label of the reflected object and the location of the bounding box of the object, in the predicted area of the bounding box in the frame input later;
an arbitration unit of the object detection device, when frame input period is denoted as 1/F second, processing time of the first detection unit corresponding to one period is denoted as PH seconds, and processing time of the second detection unit corresponding to one period is denoted as PL seconds, controls turning on and off of a start prohibition flag which is to prohibit start of a processing of the first detection unit, based on 1/F, PH and PL; and
the first detection unit starts the processing when the start prohibition flag is off.

### (Supplementary Note 4)

The object detection method according to supplementary note 3,
wherein the arbitration unit turns on the start prohibition flag (1/F-PL-PH) seconds after end of the processing time of the second detection unit corresponding to one period, and turns off the start prohibition flag at any time from immediately after start of the processing time of the second detection unit corresponding to next period to the end the processing time.

### (Supplementary Note 5)

A non-transitory computer-readable recording medium in which an object detection program is recorded, wherein the object detection program is to be installed in a computer to which frames are input consecutively, and the object detection program causes the computer to execute:
a first detection process of identifying a label of an object reflected in an input frame and a location of a bounding box of the object, and predicting an area of the bounding box in a frame input later than the frame based on history of the location of the bounding box of the same object;
a second detection process of identifying the label of the reflected object and the location of the bounding box of the object, in the predicted area of the bounding box in the frame input later; and
an arbitration process of, when frame input period is denoted as 1/F second, processing time of the first detection process corresponding to one period is denoted as PH seconds, and processing time of the second detection process corresponding to one period is denoted as PL seconds, controlling turning on and off of a start prohibition flag which is to prohibit start of the first detection process, based on 1/F, PH and PL,
wherein the object detection program causes the computer to start the first detection process when the start prohibition flag is off.

### (Supplementary Note 6)

The non-transitory computer-readable recording medium according to supplementary note 5, wherein the object detection program causes the computer, in the arbitration process,
to turn on the start prohibition flag (1/F-PL-PH) seconds after end of the second detection process corresponding to one period, and to turn off the start prohibition flag at any time from immediately after start of the second detection process corresponding to next period to the end the processing time.

While the present disclosure has been particularly shown and described with reference to example embodiment thereof, the present disclosure is not limited to this example embodiment. It will be understood by those of ordinary skill in the art that various changes in from and details may be made therein without departing from the spirit and scope of the present disclosure as defined by the claims.

The present disclosure can be suitably applied to an object detection device that detects an object reflected in frames.

What is claimed is:

1. An object detection device to which frames are input consecutively, comprising:
a first detection unit that identifies a label of an object reflected in an input frame and a location of a bounding box of the object, and predicts an area of the bounding box in a frame input later than the frame based on history of the location of the bounding box of the same object; and
a second detection unit that identifies the label of the reflected object and the location of the bounding box of the object, in the predicted area of the bounding box in the frame input later;
wherein the first detection unit and the second detection unit share a hardware resource,
wherein the object detection device comprises:
an arbitration unit that, when frame input period is denoted as 1/F second, processing time of the first detection unit corresponding to one period is denoted as PH seconds, and processing time of the second detection unit corresponding to one period is denoted as PL seconds, controls turning on and off of a start prohibition flag which is to prohibit start of a processing of the first detection unit, based on 1/F, PH and PL, and
wherein the first detection unit starts the processing when the start prohibition flag is off.

2. The object detection device according to claim 1,
wherein the arbitration unit turns on the start prohibition flag (1/F-PL-PH) seconds after end of the processing time of the second detection unit corresponding to one period, and turns off the start prohibition flag at any time from immediately after start of the processing time of the second detection unit corresponding to next period to the end the processing time.

3. An object detection method applied to an object detection device to which frames are input consecutively,
wherein a first detection unit of the object detection device identifies a label of an object reflected in an input frame and a location of a bounding box of the object, and predicts an area of the bounding box in a frame input later than the frame based on history of the location of the bounding box of the same object;
a second detection unit of the object detection device identifies the label of the reflected object and the location of the bounding box of the object, in the predicted area of the bounding box in the frame input later;
an arbitration unit of the object detection device, when frame input period is denoted as 1/F second, processing time of the first detection unit corresponding to one period is denoted as PH seconds, and processing time of the second detection unit corresponding to one period is denoted as PL seconds, controls turning on and off of a start prohibition flag which is to prohibit start of a processing of the first detection unit, based on 1/F, PH and PL; and
the first detection unit starts the processing when the start prohibition flag is off.

4. The object detection method according to claim 3,
wherein the arbitration unit turns on the start prohibition flag (1/F-PL-PH) seconds after end of the processing time of the second detection unit corresponding to one period, and turns off the start prohibition flag at any time from immediately after start of the processing time of the second detection unit corresponding to next period to the end the processing time.

5. A non-transitory computer-readable recording medium in which an object detection program is recorded, wherein the object detection program is to be installed in a computer to which frames are input consecutively, and the object detection program causes the computer to execute:
a first detection process of identifying a label of an object reflected in an input frame and a location of a bounding box of the object, and predicting an area of the bounding box in a frame input later than the frame based on history of the location of the bounding box of the same object;
a second detection process of identifying the label of the reflected object and the location of the bounding box of the object, in the predicted area of the bounding box in the frame input later; and
an arbitration process of, when frame input period is denoted as 1/F second, processing time of the first detection process corresponding to one period is denoted as PH seconds, and processing time of the second detection process corresponding to one period is denoted as PL seconds, controlling turning on and off of a start prohibition flag which is to prohibit start of the first detection process, based on 1/F, PH and PL,
wherein the object detection program causes the computer to start the first detection process when the start prohibition flag is off.

6. The non-transitory computer-readable recording medium according to claim 5, wherein the object detection program causes the computer, in the arbitration process,
to turn on the start prohibition flag (1/F-PL-PH) seconds after end of the second detection process corresponding to one period, and to turn off the start prohibition flag at any time from immediately after start of the second detection process corresponding to next period to the end the processing time.
